(19) United States
(12) Patent Application Publication
(10) Pub. No.: US 2021/0012061 A1
(43) Pub. Date: Jan. 14, 2021

(54) SUPERVISED CROSS-MODAL RETRIEVAL FOR TIME-SERIES AND TEXT USING MULTIMODAL TRIPLET LOSS

(71) Applicants: NEC Laboratories America, Inc., Princeton, NJ (US); NEC Corporation, Tokyo (JP)

(72) Inventors: Yuncong Chen, Plainsboro, NJ (US); Dongjin Song, Princeton, NJ (US); Cristian Lumezanu, Princeton Junction, NJ (US); Haifeng Chen, West Windsor, NJ (US); Takehiko Mizoguchi, Tokyo (JP)

(21) Appl. No.: 16/918,257

(22) Filed: Jul. 1, 2020

Related U.S. Application Data
(60) Provisional application No. 62/873,255, filed on Jul. 12, 2019.

(51) Int. Cl. G06F 40/166; G06F 16/23; G06N 3/04; G06N 3/08; G06F 40/30

(52) U.S. Cl. CPC G06F 40/166; G06F 16/2379; G06F 40/30; G06N 3/08; G06N 3/04

(57) ABSTRACT

A system for cross-modal data retrieval is provided which includes a neural network having a time series encoder and text encoder jointly trained based on a triplet loss relating to two different modalities of (i) time series and (ii) free-form text comments. A database stores training sets with feature vectors extracted from encodings of the training sets. The encodings are obtained by encoding the time series using the time series encoder and encoding the text comments using the text encoder. A processor retrieves the feature vectors corresponding to at least one of the modalities from the database for insertion into a feature space together with a feature vector corresponding to a testing input relating to at least one of a testing time series and a testing free-form text comment, determines a set of nearest neighbors from among the feature vectors based on distance criteria, and outputs testing results.

### RELATED APPLICATION INFORMATION

This application claims priority to U.S. Provisional Patent Application Ser. No. 62/873,255, filed on Jul. 12, 2019, incorporated herein by reference herein its entirety.

### BACKGROUND

### Technical Field

The present invention relates to information processing and more particularly to supervised cross-modal retrieval for time series and free-form textual comments using multimodal triplet loss.

### Description of the Related Art

Time series data are prevalent in, for example, the financial and industrial worlds. The effectiveness of time series analytics are often hindered by the lack of feedback that is understandable by human users. Interpretation of time series often requires domain expertise. In many real-world scenarios, time series are tagged with comments written by human experts. Although in some cases the comments are no more than categorical labels, more often they are free-form natural texts. It is desirable to advance time series analytics towards domain awareness and interpretability with respect to the time series and the associated free-form texts.

### SUMMARY

According to aspects of the present invention, a computer processing system for cross-modal data retrieval is provided. The computer processing system includes a neural network having a time series encoder and text encoder which are jointly trained based on a triplet loss. The triplet loss relates to two different modalities of (i) time series and (ii) free-form text comments, which respectively correspond to a training set of time series and a training set of free-form text comments. The computer processing system further includes a database for storing the training sets with feature vectors extracted from encodings of the training sets. The encodings are obtained by encoding the time series in the training set of time series using the time series encoder and encoding the free-form text comments in the training set of free-form text comments using the text encoder. The computer processing system also includes a hardware processor for retrieving the feature vectors corresponding to at least one of the two different modalities from the database for insertion into a feature space together with at least one feature vector corresponding to a testing input relating to at least one of a testing time series and a testing free-form text comment, determining a set of nearest neighbors from among the feature vectors in the feature space based on distance criteria, and outputting testing results for the testing input based on the set of nearest neighbors.

According to other aspects of the present invention, a computer-implemented method for cross-modal data retrieval is provided. The method includes jointly training a neural network having a time series encoder and text encoder based on a triplet loss. The triplet loss relates to two different modalities of (i) time series and (ii) free-form text comments, which respectively correspond to a training set of time series and a training set of free-form text comments. The method further includes storing, in a database, the training sets with feature vectors extracted from encodings of the training sets. The encodings are obtained by encoding the time series in the training set of time series using the time series encoder and encoding the free-form text comments in the training set of free-form text comments using the text encoder. The method also includes retrieving the feature vectors corresponding to at least one of the two different modalities from the database for insertion into a feature space together with at least one feature vector corresponding to a testing input relating to at least one of a testing time series and a testing free-form text comment. The method additionally includes determining, by a hardware processor, a set of nearest neighbors from among the feature vectors in the feature space based on distance criteria, and outputting testing results for the testing input based on the set of nearest neighbors.

According to yet other aspects of the present invention, a computer program product for cross-modal data retrieval, the computer program product comprising a non-transitory computer readable storage medium having program instructions embodied therewith, the program instructions executable by a computer to cause the computer to perform. The method includes jointly training a neural network having a time series encoder and text encoder based on a triplet loss. The triplet loss relates to two different modalities of (i) time series and (ii) free-form text comments, which respectively correspond to a training set of time series and a training set of free-form text comments. The method further includes storing, in a database, the training sets with feature vectors extracted from encodings of the training sets. The encodings are obtained by encoding the time series in the training set of time series using the time series encoder and encoding the free-form text comments in the training set of free-form text comments using the text encoder. The method also includes retrieving the feature vectors corresponding to at least one of the two different modalities from the database for insertion into a feature space together with at least one feature vector corresponding to a testing input relating to at least one of a testing time series and a testing free-form text comment. The method additionally includes determining, by a hardware processor of the computer, a set of nearest neighbors from among the feature vectors in the feature space based on distance criteria, and outputting testing results for the testing input based on the set of nearest neighbors.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram showing an exemplary computing device, in accordance with an embodiment of the present invention;

FIG. 2 is a high level block diagram showing an exemplary system/method for cross-modal retrieval between time series and free-form textual comments, in accordance with an embodiment of the present invention;

FIGS. 3-4 are flow diagrams for a method for cross-modal retrieval between time series and free-form textual comments, in accordance with an embodiment of the present invention;

FIG. 5 is a block diagram showing an exemplary architecture of the text encoder 212 of FIG. 2, in accordance with an embodiment of the present invention;

FIG. 6 is a block diagram showing an exemplary architecture of the text encoder of FIG. 2, in accordance with an embodiment of the present invention; and

FIG. 7 is a block diagram showing an exemplary computing environment, in accordance with an embodiment of the present invention.

### DETAILED DESCRIPTION OF PREFERRED EMBODIMENTS

In accordance with embodiments of the present invention, systems and methods are provided for supervised cross-modal retrieval for time series and free-form textual comments using multimodal triplet loss.

Embodiments of the present invention are able to advance time series analytics towards domain awareness and interpretability by jointly learning from the time series and the associated free-form texts.

In an embodiment, the present invention focuses on the cross-modal retrieval task, where the queries and retrieved results can be of either modality. In particular, one or more embodiments of the present invention provide a neural network architecture and related retrieval algorithm to address the following three application scenarios:

(1) Explanation: given a time series segment, retrieve relevant comments which can be used as human-readable explanations of the time series segment.

(2) Natural language search: given a sentence or set of keywords, retrieve relevant time series segments.

(3) Joint-modality search: given a time series segment and a sentence or a set of keywords, retrieve relevant time series segments such that a subset of the attributes match the keywords and the remaining of the attributes are similar to the given time series segment.

In general, one or more embodiments of the present invention provide an architecture that enables the learning of a modality-agnostic notion of similarity between pairs of data items, and proposed a search algorithm to retrieve close items given a query.

To this end, two sequence encoders (a time series encoder and a text encoder) are learned from a set of data in both modalities, labeled with class information. The encoders are trained to map data instances into a common latent space, such that instances of the same class are close together and those of different classes are far from each other. Retrieval is then based on finding nearest neighbors (of any modality) to the query (which can also be in any modality) in this common latent space. If learning is successful, most of the neighbors share the same class as the query, meaning the retrieval results have high relevance to the query.

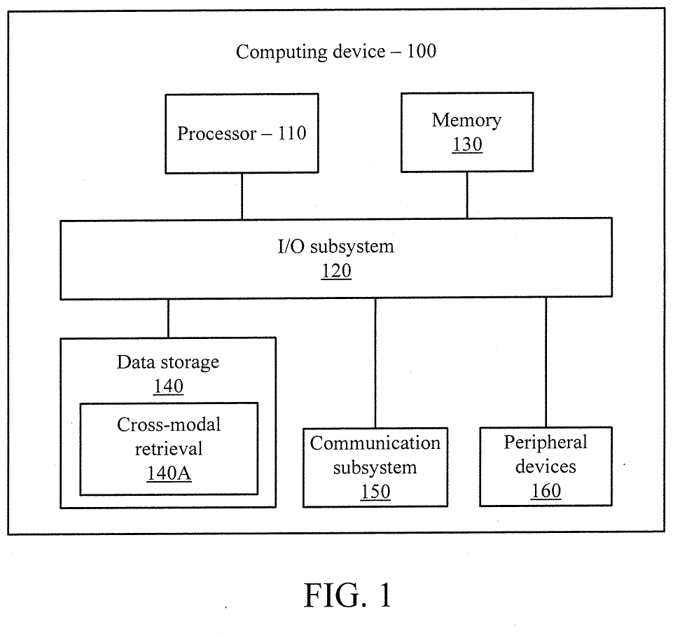

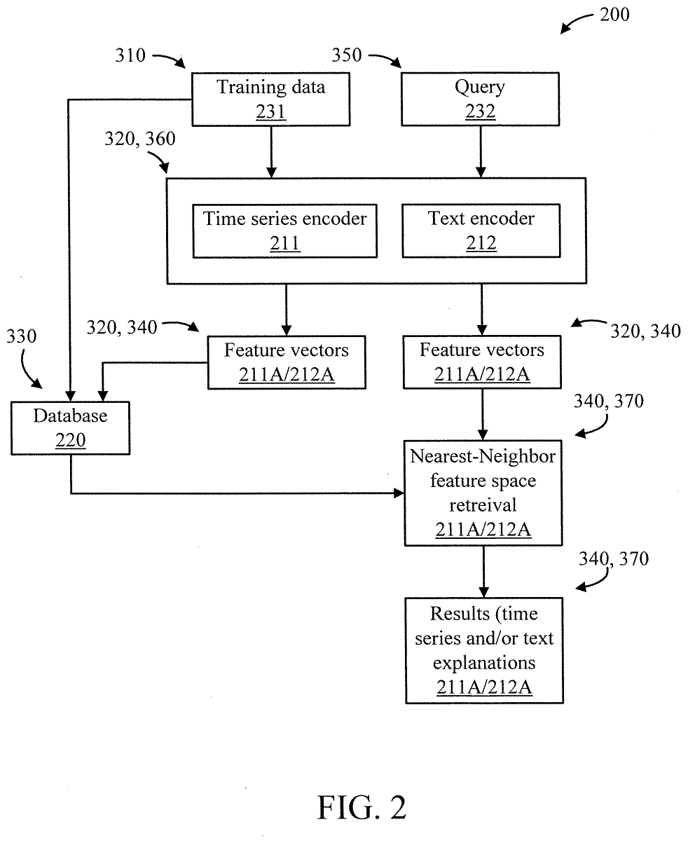

FIG. 1 is a block diagram showing an exemplary computing device 100, in accordance with an embodiment of the present invention. The computing device 100 can be part of system 200 described below with respect to FIG. 2. The computing device 100 is configured to perform cross-modal retrieval between time series and free-form textual comments.

The computing device 100 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 100 may be embodied as a one or more compute sleds, memory sleds, or other racks, sleds, computing chassis, or other components of a physically disaggregated computing device. As shown in FIG. 1, the computing device 100 illustratively includes the processor 110, an input/output subsystem 120, a memory 130, a data storage device 140, and a communication subsystem 150, and/or other components and devices commonly found in a server or similar computing device. Of course, the computing device 100 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 130, or portions thereof, may be incorporated in the processor 110 in some embodiments.

The processor 110 may be embodied as any type of processor capable of performing the functions described herein. The processor 110 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 130 may be embodied as any type of volatile or non-volatile memory or data storage capable of performing the functions described herein. In operation, the memory 130 may store various data and software used during operation of the computing device 100, such as operating systems, applications, programs, libraries, and drivers. The memory 130 is communicatively coupled to the processor 110 via the I/O subsystem 120, which may be embodied as circuitry and/or components to facilitate input/output operations with the processor 110 the memory 130, and other components of the computing device 100. For example, the I/O subsystem 120 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.) and/or other components and subsystems to facilitate the input/output operations. In some embodiments, the I/O subsystem 120 may form a portion of a system-on-a-chip (SOC) and be incorporated, along with the processor 110, the memory 130, and other components of the computing device 100, on a single integrated circuit chip.

The data storage device 140 may be embodied as any type of device or devices configured for short-term or long-term storage of data such as, for example, memory devices and circuits, memory cards, hard disk drives, solid state drives, or other data storage devices. The data storage device 140 can store program code 140A for cross-modal retrieval between time series and free-form textual comments. The communication subsystem 150 of the computing device 100 may be embodied as any network interface controller or other communication circuit, device, or collection thereof, capable of enabling communications between the computing device 100 and other remote devices over a network. The communication subsystem 150 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 100 may also include one or more peripheral devices 160. The peripheral devices 160 may include any number of additional input/output devices, interface devices, and/or other peripheral devices. For example, in some embodiments, the peripheral devices 160 may include a display, touch screen, graphics circuitry, keyboard, mouse, speaker system, microphone, network interface, and/or other input/output devices, interface devices, and/or peripheral devices.

Of course, the computing device 100 may also include other elements (not shown), as readily contemplated by one of skill in the art, as well as omit certain elements. For example, various other input devices and/or output devices can be included in computing device 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 100 are readily contemplated by one of ordinary skill in the art given the teachings of the present invention provided herein.

As employed herein, the term “hardware processor subsystem” or “hardware processor” can refer to a processor, memory (including RAM, cache(s), and so forth), software (including memory management software) or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention

FIG. 2 is a high level block diagram showing an exemplary system/method 200 for cross-modal retrieval between time series and free-form textual comments, in accordance with an embodiment of the present invention.

The system/method 200 includes an encoding portion 210 having a time series encoder 211 and a text encoder 212, and further includes a database 220.

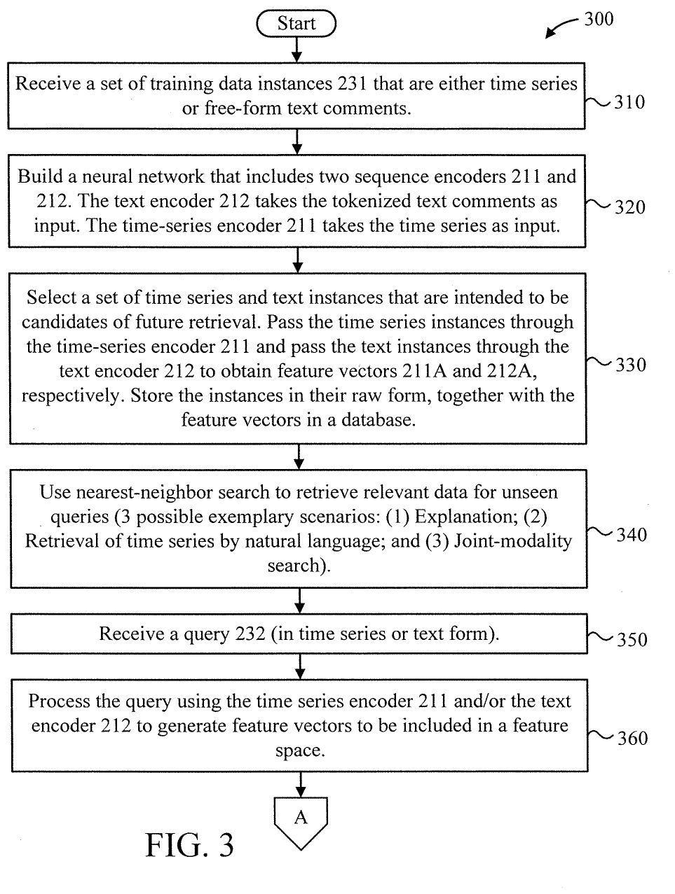

Operation of the elements of the system/method 200 is described with respect to FIG. 3.

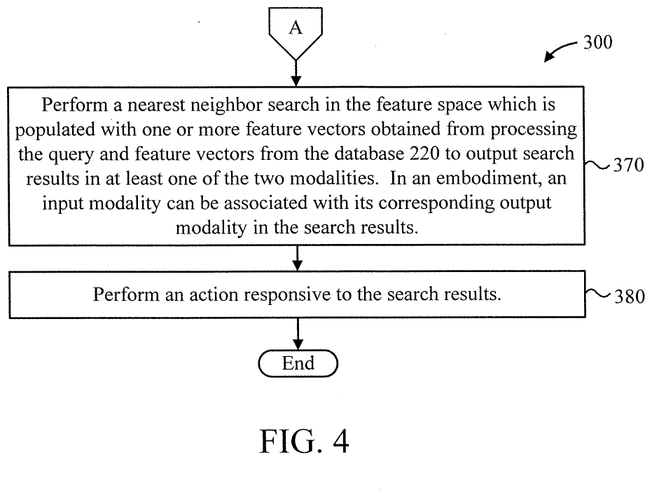

FIGS. 3-4 are flow diagrams for a method for cross-modal retrieval between time series and free-form textual comments, in accordance with an embodiment of the present invention.

At block 310, receive a set of training data instances 231 that are either time series or free-form text comments.

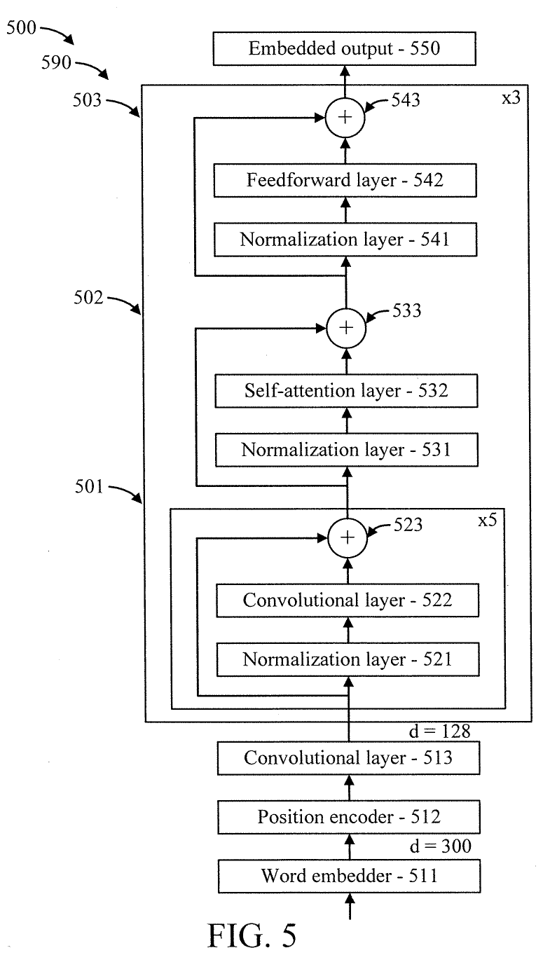

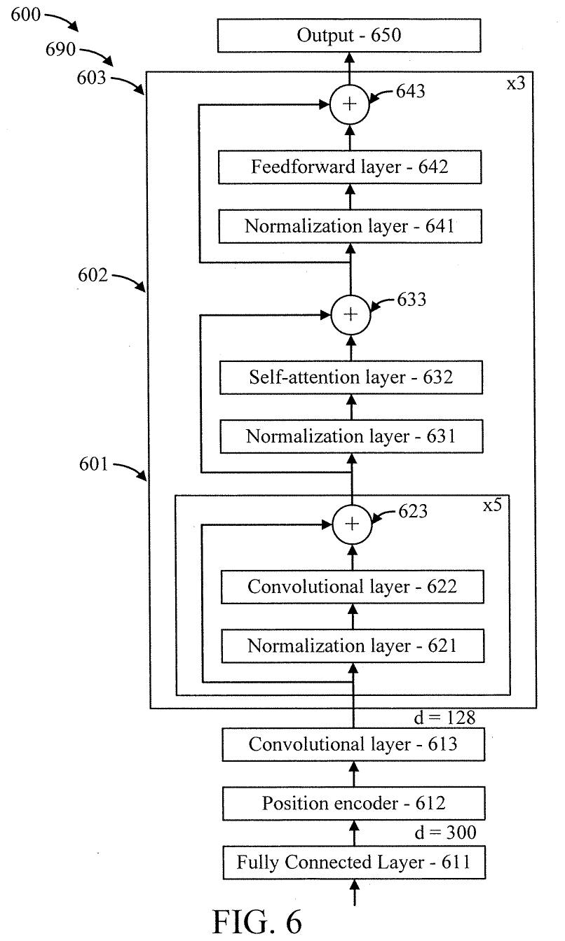

At block 320, build a neural network that includes two sequence encoders 211 and 212. The text encoder 212, denoted by g^{txt}, takes the tokenized (e.g., phrase, word, word root, etc.) text comments as input. The time-series encoder 211, denoted by g^{srs}, takes the time series as input. The text encoder 212 is shown in further detail with respect to FIG. 4. The time-series encoder 211 (shown in further detail with respect to FIG. 5) has the same architecture as shown for the text encoder 212 of FIG. 6, except that the word embedding 511 is replaced with a full connected layer 611.

The architecture 400 of the text encoder 212 shown in FIG. 4 includes a series of convolution layers 413 and 422 followed by a transformer network 490. The convolution layers capture local contexts (e.g. phrases for text data). The transformer encodes the longer term dependencies in the sequence.

In the training phase of the neural network, triplets are sampled from the data set. A triplet is a tuple of three data instances (a, p, n), each can be of either modality, such that p has the same class as a while n is from a different class.

The parameters of both encoders 211 and 212 are trained jointly by minimizing the triplet loss. This loss encourages the learning of transforms such that after the transform, instances of the same class stay close and instances of different classes are separated by a specified margin α. The triplet loss for a batch of triplets, denoted Ω, is defined as follows:

L=Σ_{(a,p,n)∈Ω}max(0,∥f(a)−f(p))∥₂−∥f(a)−f(n)∥₂+α (1)

where f=g^{txt} if the input is a time series, and g^{srs} if the input is a text comment.

A hard-example-mining strategy is used to select triplets that are “semi-hard”, which allows training to progress significantly faster than selecting triplets uniformly at random. A semi-hard triplet (a, p, n) is one that, under the current transform, barely violates the margin criteria. Formally, it satisfies the following condition:

a>∥f(a)−f(n)∥₂−∥f(a)−f(p)∥₂>0

There is no restriction on the modalities of the instances in a triplet, allowing triplets of single modality as well as mixed modalities such as (text, series, text), (series text, series), and so forth.

The training proceeds in iterations. At each iteration, a fixed batch of semi-hard triplets are sampled. The triplet loss for the batch is optimized, updating the parameters of the network using stochastic gradient descent.

At block 330 (corresponding to after the network is trained), select a set of time series and text instances that are intended to be candidates of future retrieval. Pass the time series instances through the time-series encoder 211 and pass the text instances through the text encoder 212 to obtain feature vectors 211A and 212A, respectively. Store the instances in their raw form, together with the feature vectors in a database.

At block 340, use nearest-neighbor search to retrieve relevant data for unseen queries, with the encoders 211 and 212 and database 220 available. The specific procedure for each of the three application scenarios are described below:

(1) Explanation: given the query as a time series of arbitrary length, it is forward-passed through the time-series encoder to obtain a feature vector x. Then from the database 220, find the k text instances that have the smallest (Euclidean) distance to this vector (aka. nearest neighbors). These text instances, which are human-written free-form comments, are returned as retrieval results.

(2) Retrieval of time series by natural language: given the query as a free-form text passage (i.e. words or short sentences), it is passed through the text encoder 212 to obtain a feature vector y. Then from the database 220, find the k time-series instances that have the smallest distance to y. These time series, which have the same semantic class as the query text and therefore have high relevance to the query, are returned as retrieval results.

(3) Joint-modality search: given the query as a pair of (time series segment, text passage), the time series is passed through the time-series encoder 211 to obtain a feature vector x 211A, and the text passage is passed through the text encoder 212 to obtain a feature vector y 212A. Then, from the database 220, find then time-series nearest neighbors 240 of x and n time-series nearest neighbors of y, and obtain their intersection. Start from n=k. If the number of instances in the intersection is smaller than k, increment n and repeat the search, until at least k instances are retrieved. These instances, semantically similar to both the query time series and the query text, are returned as retrieval results 250.

At block 350, receive a query 232. The query 232 can be in time series or text form.

At block 360, process the query using the time series encoder 211 and/or the text encoder 212 to generate feature vectors to be included in a feature space.

At block 370, perform a nearest neighbor search in the feature space which is populated with one or more feature vectors obtained from processing the query and feature vectors from the database 220 to output search results in at least one of the two modalities. In an embodiment, an input modality can be associated with its corresponding output modality in the search results, where the input and output modalities differ or include one or more of the same modalities on either end (input or output, depending upon the implementation and corresponding system configuration to that end as readily appreciated given the teachings provided herein).

At block 380, perform an action responsive to the search results.

Exemplary actions can include, for example, but are not limited to, recognizing anomalies in computer processing systems and controlling the system in which an anomaly is detected. For example, a query in the form of time series data from a hardware sensor or sensor network (e.g., mesh) can be characterized as anomalous behavior (dangerous or otherwise too high operating speed (e.g., motor, gear junction), dangerous or otherwise excessive operating heat (e.g., motor, gear junction), dangerous or otherwise out of tolerance alignment (e.g., motor, gear junction, etc.) using a text message as a label. In a processing pipeline, an initial input time series can be processed into multiple text messages and then recombined to include a subset of the text messages for a more focused resultant output time series with respect to a given topic (e.g., anomaly type). Accordingly, a device may be turned off, its operating speed reduced, an alignment (e.g., hardware-based) procedure is performed, and so forth, based on the implementation.

Another exemplary action can be operating parameter tracing where a history of the parameters change over time can be logged as used to perform other functions such as hardware machine control functions including turning on or off, slowing down, speeding up, positionally adjusting, and so forth upon the detection of a given operation state equated to a given output time series and/or text comment relative to historical data.

FIG. 5 is a block diagram showing an exemplary architecture 500 of the text encoder 212 of FIG. 2, in accordance with an embodiment of the present invention.

The architecture 500 includes a word embedder 511, a position encoder 512, a convolutional layer 513, a normalization layer 521, a convolutional layer 522, a skip connection 523, a normalization layer 531, a self-attention layer 532, a skip connection 533, a normalization layer 541, a feedforward layer 542, and a skip connection 543. The architecture 500 provides an embedded output 550.

The above elements form a transformation network 590.

The input is a text passage. Each token of the input is transformed into word vectors by the word embedding layer 511. The position encoder 512 then appends each token's position embedding vector to the token's word vector. The resulting embedding vector is feed to an initial convolution layer 513, followed by a series of residual convolution blocks 501 (with one shown for the sakes of illustration and brevity). Each residual convolution block 501 includes a batch-normalization layer 521 and a convolution layer 522, and a skip connection 523. Next is a residual self-attention block 502. The residual self-attention block 502 includes a batch-normalization layer 531 and a self-attention layer 532 and a skip connection 533. Next is a residual feedforward block 503. The residual feedforward block 503 includes a batch-normalization layer 541, a fully connected linear feedforward layer 542, and a skip connection 543. The output vector 550 from this block is the output of the entire transformation network and is the feature vector for the input text.

This particular architecture 500 is just one of many possible neural network architectures that can fulfill the purpose of encoding text messages to vectors. Besides the particular implementation above, the text encoder can be implemented using many variants of recursive neural networks or 1-dimensional convolutional neural networks. These and other architecture variations are readily contemplated by one of ordinary skill in the art, given the teachings of the present invention provided herein.

FIG. 6 is a block diagram showing an exemplary architecture 600 of the time series encoder 211 of FIG. 2, in accordance with an embodiment of the present invention.

The architecture 600 includes a word embedder 611, a position encoder 612, a convolutional layer 613, a normalization layer 621, a convolutional layer 622, a skip connection 623, a normalization layer 631, a self-attention layer 632, a skip connection 633, a normalization layer 641, a feedforward layer 642, and a skip connection 643. The architecture provides an output 650.

The above elements form a transformation network 690.

The input is a time series of fixed length. The data vector at each time point is transformed by a fully connected layer to a high dimensional latent vector. The position encoder then appends a position vector to each timepoint's latent vector. The resulting embedding vector is feed to an initial convolution layer 613, followed by a series of residual convolution blocks 601 (with one shown for the sakes of illustration and brevity). Each residual convolution block 601 includes a batch-normalization layer 621 and a convolution layer 622, and a skip connection 623. Next is a residual self-attention block 602. The residual self-attention block 602 includes a batch-normalization layer 631 and a self-attention layer 632 and a skip connection 633. Next is a residual feedforward block 603. The residual feedforward block 603 includes a batch-normalization layer 641, a fully connected linear feedforward layer 642, and a skip connection 643. The output vector 650 from this block is the output of the entire transformation network and is the feature vector for the input time series.

This particular architecture 600 is just one of many possible neural network architectures that can fulfill the purpose of encoding time series to vectors. Besides the time-series encoder can be implemented using many variants of recursive neural networks or temporal dilational convolution neural networks.

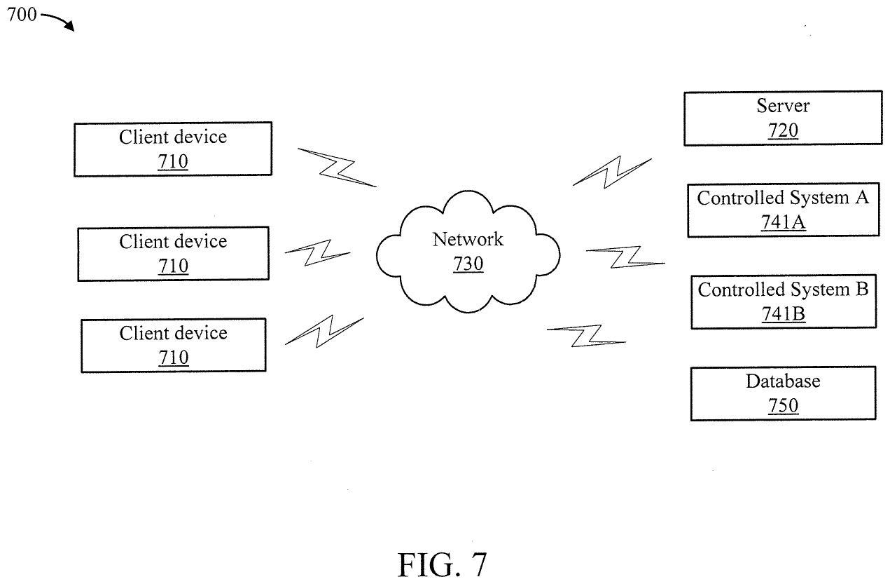

FIG. 7 is a block diagram showing an exemplary computing environment 700, in accordance with an embodiment of the present invention.

The environment 700 includes a server 710, multiple client devices (collectively denoted by the figure reference numeral 720), a controlled system A 741, a controlled system B 742, and a remote database 750.

Communication between the entities of environment 700 can be performed over one or more networks 730. For the sake of illustration, a wireless network 730 is shown. In other embodiments, any of wired, wireless, and/or a combination thereof can be used to facilitate communication between the entities.

The server 710 receives queries from client devices 720. The queries can be in time series and/or text comments form. The server 710 may control one of the systems 741 and/or 742 based on query results derived by accessing the remote database 750 (to obtain feature vectors for populating a feature space together with feature vectors extracted from the query). In an embodiment, the query can be data related to the controlled systems 741 and/or 742 such as, for example, but not limited to sensor data.

While the database 750 is shown as remote, and envisioned shared amongst multiple monitored systems in a distributed environment (have tens if not possible hundreds of monitored and controlled systems such as 741 and 742), in other embodiments the database 750 can be incorporated into server 710.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer processing system for cross-modal data retrieval, comprising:
a neural network having a time series encoder and text encoder which are jointly trained based on a triplet loss, the triplet loss relating to two different modalities of (i) time series and (ii) free-form text comments, which respectively correspond to a training set of time series and a training set of free-form text comments;
a database for storing the training sets with feature vectors extracted from encodings of the training sets, the encodings obtained by encoding the time series in the training set of time series using the time series encoder and encoding the free-form text comments in the training set of free-form text comments using the text encoder; and
a hardware processor for retrieving the feature vectors corresponding to at least one of the two different modalities from the database for insertion into a feature space together with at least one feature vector corresponding to a testing input relating to at least one of a testing time series and a testing free-form text comment, determining a set of nearest neighbors from among the feature vectors in the feature space based on distance criteria, and outputting testing results for the testing input based on the set of nearest neighbors.

2. The computer processing system of claim 1, wherein the triplet loss is for triplets from both of the two different modalities such that a first and a second triplet value are from a same semantic class and a third triplet value is from a different semantic class from among a plurality of semantic classes in which various one of the two different modalities are characterized.

3. The computer processing system of claim 1, wherein the hardware processor performs the insertion into the feature space by applying a sampling method to triplets corresponding to at least one of the training set of time series and the training set of free-form text comments, the sampling method only selecting particular ones of the feature vectors that are outside a pre-specified margin separating at least two different semantic classes in a given tuple by less than a threshold margin violation amount.

4. The computer processing system of claim 1, wherein the time series encoder and the text encoder are jointly trained by learning transforms such that after an application of the transforms to instances of a same semantic class from the training sets, the instances of the same semantic class remain close in the feature space within a given threshold distance while instances of different semantic classes are separated in the feature space by at least a specified margin distance different than the given threshold distance.

5. The computer processing system of claim 4, wherein the hardware processor performs the insertion into the feature space by applying a sampling method to triplets corresponding to at least one of the training sets, the sampling method only selecting particular ones of the feature vectors that are outside the pre-specified margin distance by less than a threshold margin violation amount.

6. The computer processing system of claim 1, where the testing input is an input time series of arbitrary length applied to the time series encoder to obtain the testing results as an explanation of the input time series in a form of one or more free-form text comments.

7. The computer processing system of claim 1, wherein the testing input is an input free-form text comment of arbitrary length applied to the text encoder to obtain the testing results as one or more time series having a same semantic class as the input free-form text comment.

8. The computer processing system of claim 1, wherein the testing input comprise both an input time series of arbitrary length applied to the time series encoder to obtain a first vector for the insertion into the feature space and an input free-form text comment of arbitrary length applied to the text encoder to obtain a second vector for the insertion into the feature space.

9. The computer processing system of claim 1, wherein the triplet loss is optimized by updating parameters of the neural network using stochastic gradient descent.

10. The computer processing system of claim 1, wherein the testing input comprises a tuple of a text segment, a time series segment, and another text segment.

11. The computer processing system of claim 1, wherein multiple convolutional layers of the neural network capture local contexts and a transformed network of the neural network captures long term context dependencies relative to the local contexts.

12. The computer processing system of claim 1, wherein the testing input comprises a given time series data at least one hardware sensor for anomaly detection of a hardware system.

13. The computer processing system of claim 12, wherein the hardware processor controls the hardware system responsive to testing results.

14. A computer-implemented method for cross-modal data retrieval, comprising:
jointly training a neural network having a time series encoder and text encoder based on a triplet loss, the triplet loss relating to two different modalities of (i) time series and (ii) free-form text comments, which respectively correspond to a training set of time series and a training set of free-form text comments;
storing, in a database, the training sets with feature vectors extracted from encodings of the training sets, the encodings obtained by encoding the time series in the training set of time series using the time series encoder and encoding the free-form text comments in the training set of free-form text comments using the text encoder;
retrieving the feature vectors corresponding to at least one of the two different modalities from the database for insertion into a feature space together with at least one feature vector corresponding to a testing input relating to at least one of a testing time series and a testing free-form text comment; and
determining, by a hardware processor, a set of nearest neighbors from among the feature vectors in the feature space based on distance criteria, and outputting testing results for the testing input based on the set of nearest neighbors.

15. The computer-implemented method of claim 14, wherein the triplet loss is for triplets from both of the two different modalities such that a first and a second triplet value are from a same semantic class and a third triplet value is from a different semantic class from among a plurality of semantic classes in which various one of the two different modalities are characterized.

16. The computer-implemented method of claim 14, wherein the insertion into the feature space is performed by applying a sampling method to triplets corresponding to at least one of the training set of time series and the training set of free-form text comments, the sampling method only selecting particular ones of the feature vectors that are outside a pre-specified margin separating at least two different semantic classes in a given tuple by less than a threshold margin violation amount.

17. The computer-implemented method of claim 14, wherein the time series encoder and the text encoder are jointly trained by learning transforms such that after an application of the transforms to instances of a same semantic class from the training sets, the instances of the same semantic class remain close in the feature space within a given threshold distance while instances of different semantic classes are separated in the feature space by at least a specified margin distance different than the given threshold distance.

18. The computer-implemented method of claim 17, wherein the insertion into the feature space is performed by applying a sampling method to triplets corresponding to at least one of the training sets, the sampling method only selecting particular ones of the feature vectors that are outside the pre-specified margin distance by less than a threshold margin violation amount.

19. The computer-implemented method of claim 14, where the testing input is an input time series of arbitrary length applied to the time series encoder to obtain the testing results as an explanation of the input time series in a form of one or more free-form text comments.

20. A computer program product for cross-modal data retrieval, the computer program product comprising a non-transitory computer readable storage medium having program instructions embodied therewith, the program instructions executable by a computer to cause the computer to perform a method comprising:
jointly training a neural network having a time series encoder and text encoder based on a triplet loss, the triplet loss relating to two different modalities of (i) time series and (ii) free-form text comments, which respectively correspond to a training set of time series and a training set of free-form text comments;
storing, in a database, the training sets with feature vectors extracted from encodings of the training sets, the encodings obtained by encoding the time series in the training set of time series using the time series encoder and encoding the free-form text comments in the training set of free-form text comments using the text encoder;
retrieving the feature vectors corresponding to at least one of the two different modalities from the database for insertion into a feature space together with at least one feature vector corresponding to a testing input relating to at least one of a testing time series and a testing free-form text comment; and
determining, by a hardware processor of the computer, a set of nearest neighbors from among the feature vectors in the feature space based on distance criteria, and outputting testing results for the testing input based on the set of nearest neighbors.
